(19) United States
(12) Patent Application Publication
(10) Pub. No.: US 2015/0187015 A1
(43) Pub. Date: Jul. 2, 2015

(54) SYSTEM AND METHOD FOR DESTINATION BASED UNDERWRITING

(71) Applicant: Hartford Fire Insurance Company, Hartford, CT (US)

(72) Inventors: Isaac D. Adams, Canton, CT (US); Steven J. Fernandes, West Hartford, CT (US); Marc J. Natrillo, Avon, CT (US); Paul Brendan Olson, Hartford, CT (US); Pankaj Prakash, Rocky Hill, CT (US)

(73) Assignee: Hartford Fire Insurance Company, Hartford, CT (US)

(21) Appl. No.: 14/145,181

(22) Filed: Dec. 31, 2013

(51) Int. Cl. G06Q 40/08

(52) U.S. Cl. CPC G06Q 40/08

(57) ABSTRACT

A system for determining risk associated with a driver, the system comprising a receiver, configured to receive information associated with telematics data; a processor further configured to determine, based at least in part on the telematics data, that a vehicle has reached a destination, a length of time spent at the destination and a times of day during which the vehicle is at the destination; the processor configured to determine a direct exposure rating based on at least the determined destination, the length of time spent at the destination, and the times of day during which the vehicle is at the location; the processor further configured to adjust an insurance pricing information based on the direct exposure rating; and a transmitter configured to transmit the adjusted pricing information to a user device.

### INCORPORATION BY REFERENCE

The following documents are incorporated herein by reference as if fully set forth: U.S. application Ser. No. 14/145,142, titled SYSTEM AND METHOD FOR DETERMINING DRIVER SIGNATURES filed Dec. 31, 2013; U.S. application Ser. No. 14/145,165, titled SYSTEM AND METHOD FOR EXPECTATION BASED PROCESSING filed Dec. 31, 2013; and U.S. application Ser. No. 14/145,205, titled SYSTEM AND METHOD FOR TELEMATICS BASED UNDERWRITING filed Dec. 31, 2013. Each of the applications shares common inventorship with the present application and are being filed concurrently.

### BACKGROUND

A vehicle insurance policy may include several types of coverage: bodily injury liability, property damage liability, medical payments, uninsured motorist protection, collision coverage and comprehensive (physical damage). Demographic or biographic factors may be used as a proxy for actual driving information to determine insurance rates for a policy. In this way, in lieu of twenty four hour monitoring of driving behavior, insurance companies have correlated biographical indicators with the chances of a claim (expected losses) being filed.

When examining these biographical factors, the expected losses for a policy may be determined based not only on the driver, but the location in which the vehicle is expected to be parked (i.e. at home). As an example, comprehensive coverage covers damage to a car from theft, vandalism, fire, wind, flood, and other non-accident causes and as a result, the location and duration at which a vehicle is parked may be a larger risk factor than the skill of the driver for this coverage. For example, the risk of non-accident claims may be dramatically higher in urban settings.

As a result, where allowable by law, insurers factor in a customer's garaging or home address in determining the insurance rate. These territory rates, as they are generally known, are based on zip codes. Urban areas, which include higher population densities and heavier traffic, typically result in more losses than rural areas and in some cases these urban areas may be assessed a higher rate. However, this zip code based rate adjustment may not provide an accurate picture of the risks associated with a vehicle and may therefore not provide a useful estimate of losses. For, example two homeowners, in the same neighborhood (but straddling a zip code line) may be assessed different rates. Conversely, two neighbors may live in the same condominium, but choose to garage their vehicles in different parking locations, where one may be dramatically safer than another.

Accordingly, methods and apparatus using telematics are described for destination based underwriting.

### SUMMARY

The embodiments described herein relate to a new rating paradigm primarily based on location, type and duration of a vehicle's destination. The system may use data such as the type of destination (e.g. restaurant, amusement park, supermarket and a library, etc.) to make predictions about the riskiness of the various destinations and the correlations to loss for that vehicle. The system may use historical loss data associated with each destination as an indicator of the riskiness of the destination as well as the loss experience of other drivers frequenting that same location or type of location. Accordingly, destinations may be ranked hierarchically in relative risk to one another such as from riskiest to least risky with length of time parked at various destinations used as a rating factor. This type of underwriting may also leverage commercial insurance with respect to riskiness of businesses as destinations as an input into the consumer insurance ratings.

A system is disclosed for determining risk associated with a driver, the system comprising: a computer memory for receiving biographical information associated with one or more drivers, the biographical information including at least a home or garaging address; the memory further configured to store location based loss data; a processor configured to generate an initial risk assessment based on a correlation between the home address and the location based loss data; the processor further configured to generate an insurance quote based at least in part on the initial risk assessment; a receiver, configured to receive from a telematics device, telematics data indicating at least vehicle location and speed; the processor further configured to determine, based at least in part on the telematics data, that a vehicle has reached a destination, and to determine the length of time spent at the destination; the processor configured to determine a direct exposure rating and an indirect exposure rating based on at least the determined destination and length of time spent at the destination; and the processor further configured to adjust insurance pricing information based on the indirect exposure rating and direct exposure rating.

### BRIEF DESCRIPTION OF THE DRAWINGS

A more detailed understanding may be had from the following description, given by way of example in conjunction with the accompanying drawings wherein:

FIG. 1 shows an example system that may be used for destination based underwriting;

FIG. 2 shows a flow diagram for a method for destination based underwriting;

FIG. 3 is an example web page for initiating a request for a vehicle insurance quote;

FIG. 4 is an example web page soliciting preliminary information regarding a request for a vehicle insurance quote;

FIG. 5 is an example web page soliciting additional preliminary information regarding a request for a vehicle insurance quote;

FIG. 6 is an example web page soliciting name and address information of the individual requesting an insurance quote;

FIG. 7 is an example web page soliciting vehicle information regarding a request for a vehicle insurance quote;

FIG. 8 is an example web page soliciting additional vehicle information regarding a request for a vehicle insurance quote;

FIG. 9 is an example web page soliciting driver information regarding a request for a vehicle insurance quote;

FIG. 10 is an example web page soliciting additional driver information regarding a request for a vehicle insurance quote;

FIG. 11 is another example web page soliciting additional driver information regarding a request for a vehicle insurance quote;

FIG. 12 is an example web page soliciting driver history information regarding a request for a vehicle insurance quote;

FIG. 13 is an example web page soliciting a response from the user for registration to TrueLane® telematics program;

FIG. 14 shows an example of a location risk map used in accordance with one embodiment;

FIG. 15 shows an example electronic device that may be used to implement features described herein with reference to FIGS. 1-14; and

FIG. 16 shows a flow diagram for a method for destination based underwriting.

### DETAILED DESCRIPTION

Disclosed herein are processor-executable methods, computing systems, and related technologies for destination based underwriting, wherein the pricing for coverage may be modified based on the determined destinations of a vehicle, the length of time and the time of day the vehicle remains at each destination.

Telematics data, such as the destination may be used to determine a risk score associated with one or more coverages, such as bodily injury liability, property damage liability, medical payments, uninsured motorist protection, collision coverage and comprehensive (physical damage). For example, the telematics data may be used to determine a risk score associated with comprehensive coverage. In this example, a location risk factor, entitled driving location risk information (DLRI) score may be used to adjust pricing information based on the destination.

For example, the system may receive real time theft, weather, vehicle damage, and other information from a vendor. Based on this information, the system may determine a risk associated with each destination. For example, the system may determine that a vehicle is parked in a location with frequent hail storms. This system may determine this location may be a higher risk for loss regarding comprehensive coverage. However, the system may also determine that the vehicle is parked in a garage, which mitigates the risk. The system may use these types of factors to adjust the insurance pricing information.

As the term is used herein, the term destination may refer to any location at which a vehicle is stopped for a predetermined period of time or based on a triggering event. For example, the telematics device may report on the location of the vehicle at predetermined intervals (e.g. 1 minute, 30 seconds, 1 second, continuously, etc.). The telematics device may further be configured to report on the location of the vehicle based on triggering events (starting the ignition etc.). The system may determine that a vehicle is at a destination, if stoppage occurs for more than a predetermined amount of time, or the vehicle is turned off.

During a registration phase for vehicle insurance, an account template is opened for a potential customer. The insurance company or an insurance agent may request biographical data, for example via a webpage, to populate information in the account template. The biographical data, may include: name, age, gender, occupation, vehicle, driving history, geographical location, grades (if the driver is a student), and frequency of use of the vehicle. Once the account template is completed, the biographical data stored in the account template is formatted and stored in a database. The system, using software based statistical analysis (e.g. regression analysis) compares the biographical data with actuarial data stored in the system. This actuarial data may include statistical data related to insurance pricing and may include loss data. The system, using the results of the statistical analysis generates an initial risk assessment for the account. As an example, the risk assessment may be categorized by vehicle or by driver. This risk assessment may ultimately be used to determine whether to offer coverage, and the rate associated with the coverage.

In states where it is permissible by law, one factor that may be used in generating a risk assessment is the location in which the individual lives or the vehicle is reported to be garaged. However, the methods and apparatus described herein allow the insurance company to generate pricing information based on the distribution of locations where a vehicle was stored for any significant periods of time.

As will be described in greater detail below, telematics data is collected from the vehicle, providing the insurance company with information such as the vehicle destination, the time of day the vehicle is located at a destination, and the duration for which the vehicle is located at the destination.

The telematics data may be analyzed, based on stored information, to determine direct exposure to risks (e.g. theft, vandalism, high traffic areas) as well as indirect exposure to risks (where location is assessed to be a higher risk destination based on loss experience). A computer system may calculate pricing information based on the direct exposure risks and indirect exposure risks associated with the vehicle destinations. The pricing information may be for an overall policy adjustment or for specific coverage, such as comprehensive or uninsured motorist protection.

The telematics data may be received for a predetermined time period. In one example, a telematics device may be installed in a vehicle for a six month period over which the telematics data is collected. Because of seasonal changes in driving patterns, (e.g., for students, no school during summer time), the data processing unit 170 may be configured to account for these differences and compensate for seasonal variations by weighting the time frame of the use. Alternatively, the telematics device may be installed for a full year, or be permanently installed. In another embodiment, a software application installed on a mobile phone or other personal wireless device may be configured to generate the telematics data and communicate with the system 100.

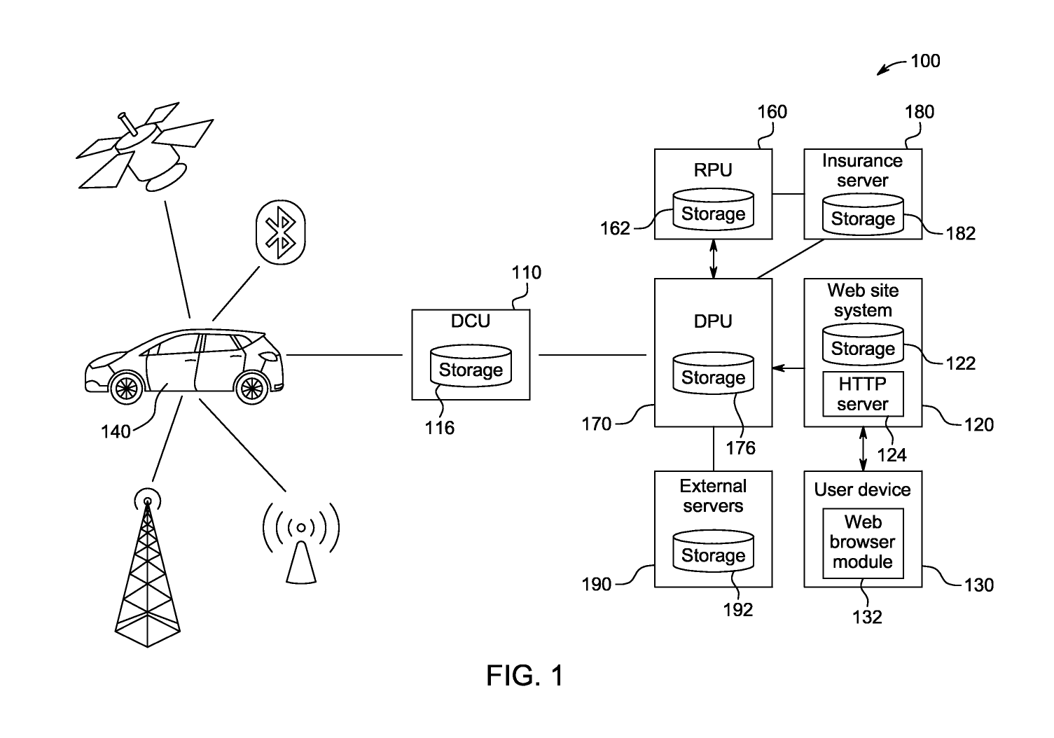

FIG. 1 shows an example system 100 that may be used for telematics based underwriting. The example system 100 includes a vehicle 140 equipped with one or more telematics devices (not pictured), for example a TrueLane® device. The telematics devices may further include smartphones, tablets and/or similar devices. The vehicle 140 may be in communication with multiple devices over different networks, including a satellite, a cellular station, a Wi-Fi hotspot, BLUETOOTH devices, and a data collection unit (DCU) 110. The DCU 110 may be operated by a third party vendor that collects telematics data. The DCU 110 may include storage 116. The DCU 110 collects the telematics data and then may transmit the telematics data to a data processing unit (DPU) 170. The telematics data may be communicated to the DPU 170 in any number of formats. In one embodiment, the DCU 110 may transmit a customized summary of the telematics data to the DPU 170, in a format useable by the DPU 170. The DPU 170 may also be configured to communicate with a risk and pricing unit (RPU) 160, including storage 162, internal insurance servers 180, including storage 182, and external servers 190 (e.g. social media networks for information that may be gathered through social networking websites such as location, activities, interests etc., official/government/public networks or websites for information that may be publically available, such as weather, traffic, crime, foreclosure data), which are all connected by one or more networks.

The one or more telematics devices associated with the vehicle 140 may communicate with a satellite, Wi-Fi hotspot and even other vehicles. The telematics devices associated with the vehicle 140 report this information to the DCU 110. As will be described in greater detail hereafter, the DCU 110 may transmit this telematics data to the DPU 170 which may be configured to consolidate biographic and telematics data to perform destination based underwriting information.

The web site system 120 provides a web site that may be accessed by a user device 130. The web site system 120 includes a Hypertext Transfer Protocol (HTTP) server module 124 and a database 122. The HTTP server module 124 may implement the HTTP protocol, and may communicate Hypertext Markup Language (HTML) pages and related data from the web site to/from the user device 130 using HTTP. The web site system 120 may be connected to one or more private or public networks (such as the Internet), via which the web site system 120 communicates with devices such as the user device 130. The web site system 120 may generate one or more web pages that may communicate the web pages to the user device 130, and may receive responsive information from the user device 130.

The HTTP server module 124 in the web site system 120 may be, for example, an APACHE HTTP server, a SUN-ONE Web Server, a MICROSOFT Internet Information Services (IIS) server, and/or may be based on any other appropriate HTTP server technology. The web site system 120 may also include one or more additional components or modules (not depicted), such as one or more load balancers, firewall devices, routers, switches, and devices that handle power backup and data redundancy.

The user device 130 is, for example, a cellular phone, a desktop computer, a laptop computer, a tablet computer, or any other appropriate computing device. The user device 130 includes a web browser module 132, which may communicate data related to the web site to/from the HTTP server module 124 in the web site system 120. The web browser module 132 may include and/or communicate with one or more sub-modules that perform functionality such as rendering HTML (including but not limited to HTML5), rendering raster and/or vector graphics, executing JAVASCRIPT, and/or rendering multimedia content. Alternatively or additionally, the web browser module 132 may implement Rich Internet Application (RIA) and/or multimedia technologies such as ADOBE FLASH, MICROSOFT SILVERLIGHT, and/or other technologies. The web browser module 132 may implement RIA and/or multimedia technologies using one or web browser plug-in modules (such as, for example, an ADOBE FLASH or MICROSOFT SILVERLIGHT plug-in), and/or using one or more sub-modules within the web browser module 132 itself. The web browser module 132 may display data on one or more display devices (not depicted) that are included in or connected to the user device 130, such as a liquid crystal display (LCD) display or monitor. The user device 130 may receive input from the user of the user device 130 from input devices (not depicted) that are included in or connected to the user device 130, such as a keyboard, a mouse, or a touch screen, and provide data that indicates the input to the web browser module 132.

The example architecture of system 100 of FIG. 1 may also include one or more wired and/or wireless networks (not depicted), via which communications between the elements in the example architecture of system 100 may take place. The networks may be private or public networks, and/or may include the Internet.

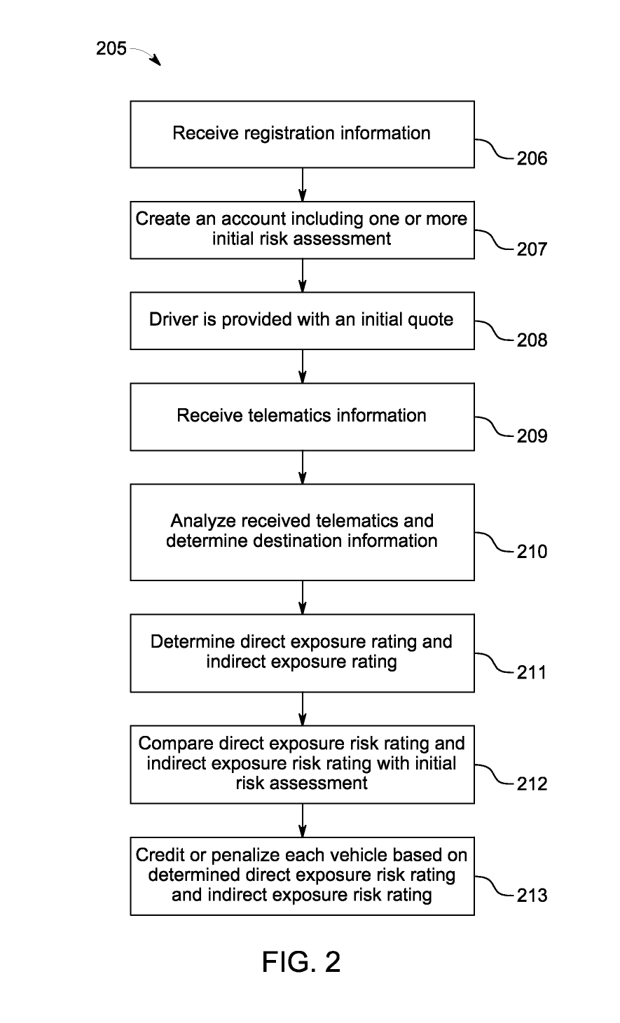

Each or any combination of the modules shown in FIG. 1 may be implemented as one or more software modules, one or more specific-purpose processor elements, or as combinations thereof. Suitable software modules include, by way of example, an executable program, a function, a method call, a procedure, a routine or sub-routine, one or more processor-executable instructions, an object, or a data structure. In addition or as an alternative to the features of these modules described above with reference to FIG. 1, these modules may perform functionality described herein with reference to FIGS. 2-16.

FIG. 2 shows an example use case for method 205 for destination based underwriting. The system 100 receives registration information regarding the user (step 206). This information may include biographical information (such as the numbers of family members, age, marital status, education, address information, number and type of vehicles). In one embodiment, this information may be received via a website. Based on this information, the system 100 creates a group account (step 207). The group account may include subaccounts for each individual driver (in the case of multiple insured). The system 100 uses a software based algorithm to generate initial risk assessments, based on stored statistical data and loss data. For example, if there are two drivers and two vehicles, and each vehicle is driven by only one driver, the system 100 generates a vehicle risk assessment which incorporates the likelihood of a claim being made related to the vehicle 140 and the expected severity of such a claim. The initial risk assessment may be based on the expected locations in which the vehicle 140 is to be stored and the expected risk behavior of the operator of the vehicle 140. The system 100 may then generate pricing information based on this initial risk assessment (step 208). For example, the pricing information may include a quote or a premium for the user. If the user accepts the premium, the account is activated and the system 100 begins receiving and storing telematics data associated with the account (step 209). At predetermined intervals or based on triggering events, the telematics device may push telematics data to the system 100, or the system 100 may pull telematics data from the device and store the information in a database. The system 100 receives the telematics data, and categorizes information as destination information (step 210). For example, the system 100 may receive location updates every 10 seconds. If the vehicle 140 is stopped, for more than a predetermined time period (e.g. 15 minutes) it may register a location as a destination location. The system 100 may further be configured to access external real-time data, such as traffic data to refine its information. For example, if a vehicle 140 is stopped for more than 15 minutes, and the location is determined to be a high traffic location, the system 100 may determine that the stoppage is not a destination, but a traffic related stoppage. The system 100 may then use the determined destination information and perform a software based statistical analysis and determine a direct exposure risk rating and an indirect exposure risk rating for each stoppage. The direct exposure risk rating and an indirect exposure risk rating are inputs to a unified Telematics Destination Score (TDS) that is calculated at some unit of location such as a zip code or a census block (step 211). The TDS, which may be comprised of a direct exposure risk rating and indirect exposure risk rating, may be compared with the initial risk assessment (step 212). Using software based algorithms, the system 100 may credit or penalize each vehicle 140 based on variances from the initial risk assessment and adjust the pricing information, wherein the adjusted pricing information may comprise a premium based on adjusted rates, credits, debits, or changes in a class plan. Additionally, the system 100 may deny coverage, or recommend a different insurance product (step 213).

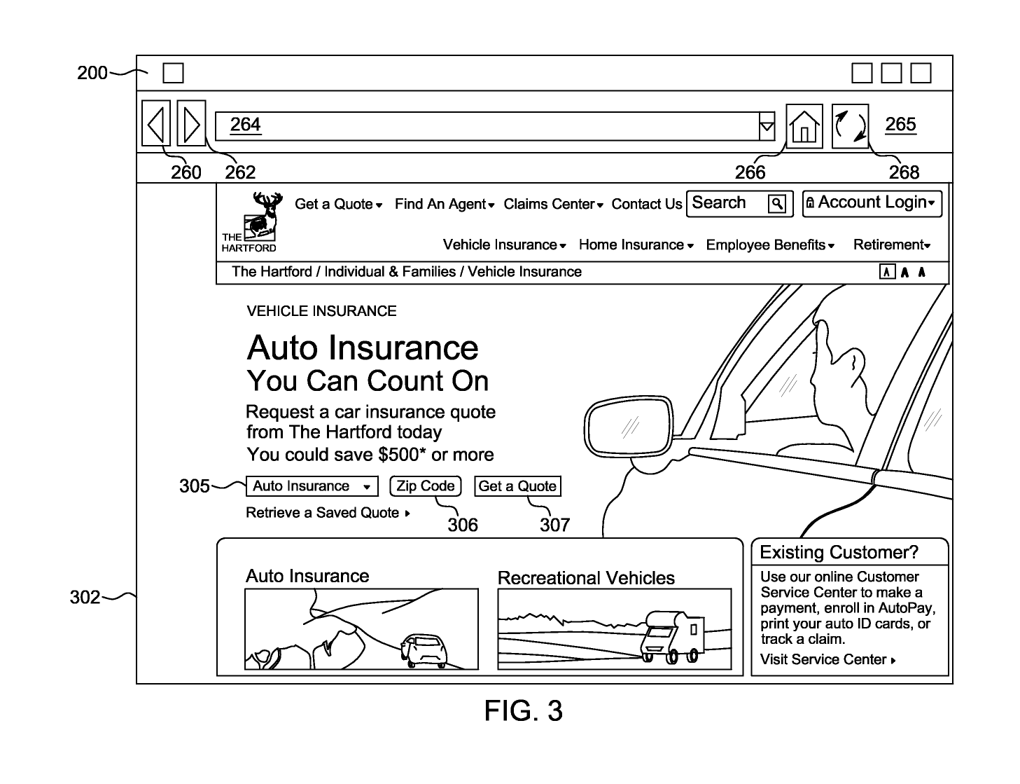

FIGS. 3-13 show example web pages that may be displayed by the web browser module 132. As will be described in detail below, the web pages may include display elements which allow the user of the user device 130 to interface with the system 100 and register or receive a quote for vehicle insurance. The web pages may be included in a web browser window 200 that is displayed and managed by the web browser module 132. The web pages may include data received by the web browser module 132 from the web site system 120. The web pages may include vehicle insurance information.

The web browser window 200 may include a control area 265 that includes a back button 260, forward button 262, address field 264, home button 266, and refresh button 268. The control area 265 may also include one or more additional control elements (not depicted). The user of the user device 130 may select the control elements 260, 262, 264, 266, 268 in the control area 265. The selection may be performed, for example, by the user clicking a mouse or providing input via keyboard, touch screen, and/or other type of input device. When one of the control elements 260, 262, 264, 266, 268 is selected, the web browser module 132 may perform an action that corresponds to the selected element. For example, when the refresh button 268 is selected, the web browser module 132 may refresh the page currently viewed in the web browser window 200.

FIG. 3 is an example web page 302 for initiating a request for a vehicle insurance quote. As shown in FIG. 3, the web page 302 may include questions accompanied by multiple input fields 305-307 in the form of drop down lists, text fields, and radio buttons. As the user provides input into the input fields 305-307, the web browser module 132 may store one or more data structures (“response data”) that reflect the selections made in the input fields 305-307. Further, as the selections are updated, the web browser module 132 may update the web page 302 to indicate additional or more specific questions that may be associated with the selections. If there are no errors in the transmission, the web browser module 132 is directed to a subsequent web page. While the example shown is for auto insurance, the methods and apparatus disclosed herein may be applied to any vehicle insurance, e.g. boats, planes, motorcycles etc. Also, while the examples are directed to family auto insurance, the methods and apparatus disclosed herein may be applicable to corporate insurance plans, or any policies covering vehicles.

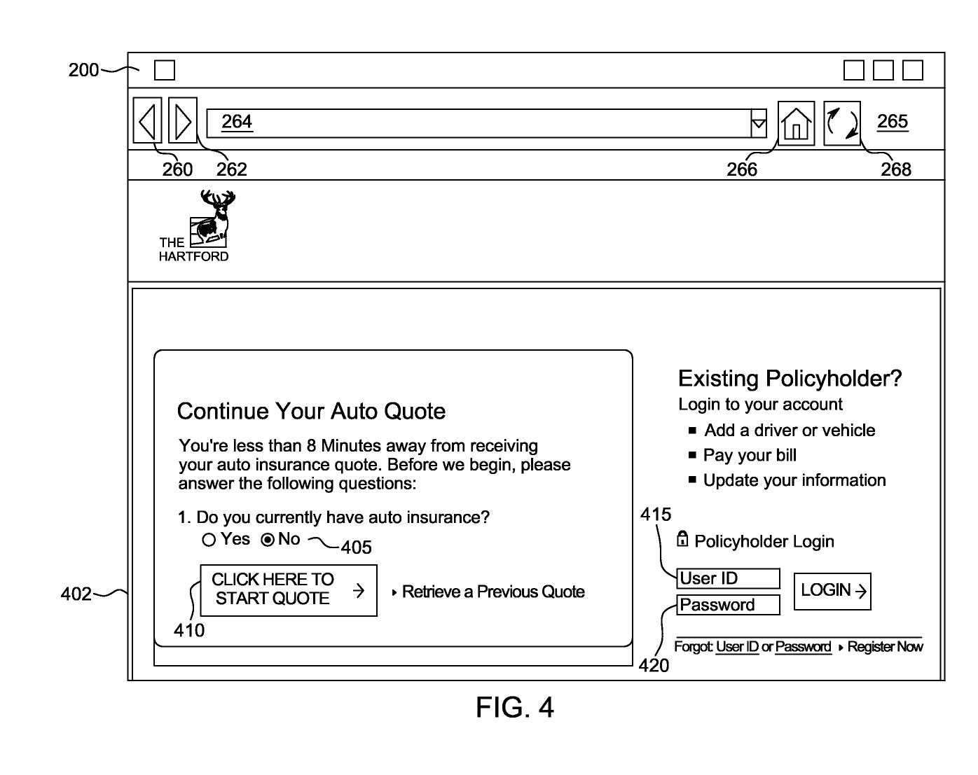

FIG. 4 is an example web page 402 soliciting preliminary information regarding a request for a vehicle insurance quote. As shown in FIG. 4, the web page 402 may include multiple input fields 405, 410, 415, and 420. As the user device 130 receives input for the input fields, the web browser module 132 may store one or more data structures (“response data”) that reflect the selections made in the input fields. Further, as the selections are updated, the web browser module 132 may update the web page 402 to indicate additional or more specific questions that may be associated with the selections. At any time, while viewing the web page 402 of FIG. 4, the user may enter user identification information in input fields 415 and 420, which accesses previously stored information associated with the user. If there are no errors in the transmission, the web browser module 132 is directed to a subsequent web page.

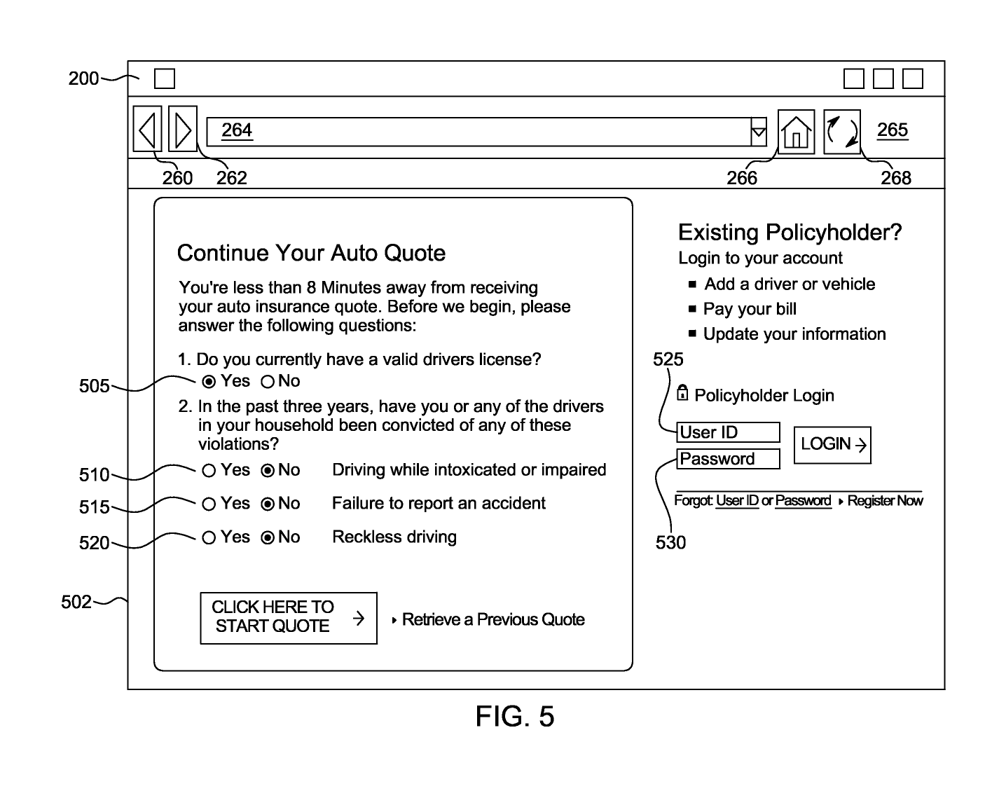

FIG. 5 is an example web page 502 soliciting additional preliminary information regarding a request for a vehicle insurance quote. As shown in FIG. 5, the web page 502 may include multiple input fields 505, 510, 515, 520, 525, and 530. As the user device 130 receives input for the input fields, the web browser module 132 may store one or more data structures (“response data”) that reflect the selections made in the input fields. Further, as the selections are updated, the web browser module 132 may update the web page 502 to indicate additional or more specific questions that may be associated with the selections. At any time, while viewing the web page 502 of FIG. 5, the user may enter user identification information in input fields 525 and 530, which accesses previously stored information associated with the user. Web page 502 solicits additional questions, for example, whether the user currently has a valid driver's license and whether the user or associated family has had any major driving violations. Such violations alert the system 100 that the user may be directed to a different insurance product. Additionally, while the telematics program is voluntary for some users, in one embodiment, a potential user may be eligible for additional products if they consent to using the telematics program, whereas previously they may have been disqualified. If there are no errors in the transmission, the web browser module 132 is directed to a subsequent web page.

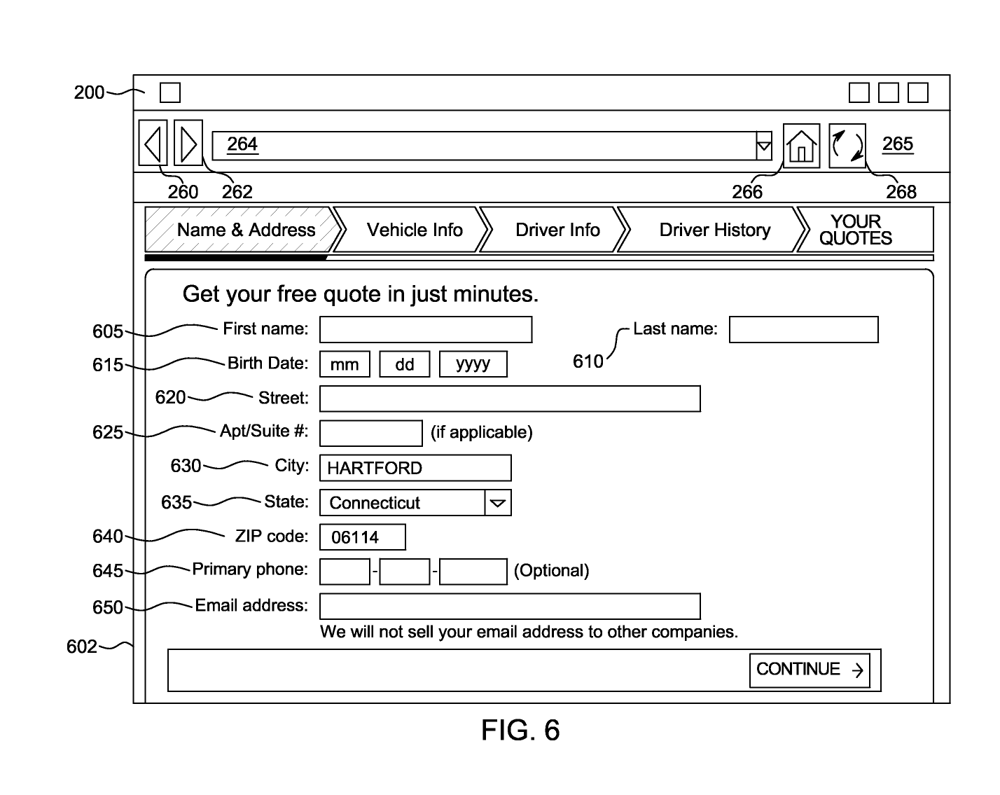

FIG. 6 is an example web page 602 soliciting name and address information of the individual requesting an insurance quote. As shown in FIG. 6, the web page 602 may include multiple input fields 605, 610, 615, 620, 625, 630, 635, 640, 645 and 650. As the user device 130 receives input for the input fields, the web browser module 132 may store one or more data structures (“response data”) that reflect the selections made in the input fields. Further, as the selections are updated, the web browser module 132 may update the web page 602 to indicate additional or more specific questions that may be associated with the selections. The questions displayed on web page 602 solicit questions regarding the contact information of the individual applying for insurance. As an example, the questions shown in FIG. 6 include: name, date of birth, address, phone number, and email address. If there are no errors in the transmission, the web browser module 132 is directed to a subsequent web page.

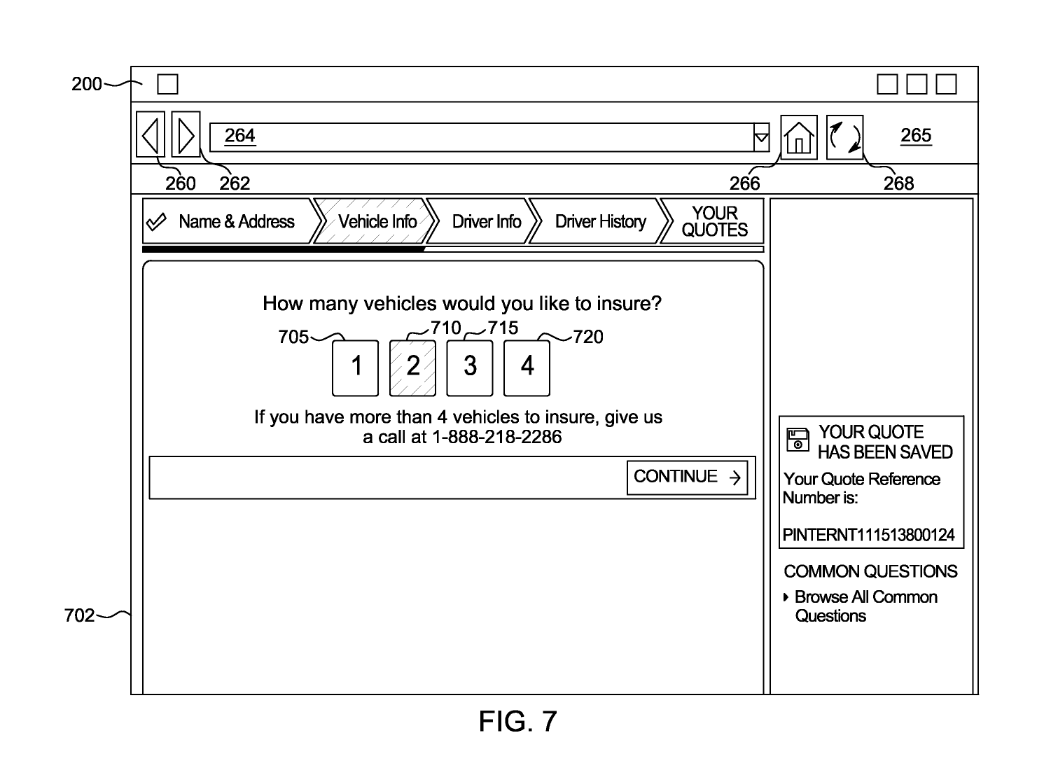

FIG. 7 is an example web page 702 soliciting vehicle information regarding a request for a vehicle insurance quote. As shown in FIG. 7, the web page 702 may include radio buttons 705, 710, 715, and 720. As the user device 130 receives input selecting a radio button, the web browser module 132 may store one or more data structures (“response data”) that reflect the selections made. Further, as the selections are updated, the web browser module 132 may update the web page 702 to indicate additional or more specific questions that may be associated with the selections. The question displayed on web page 702 solicits information regarding the number of vehicles for which insurance is being requested. While the example shown in FIG. 7 only allows four vehicles, this is as an example only. More or less vehicles may be allowed. If there are no errors in the transmission, the web browser module 132 is directed to a subsequent web page.

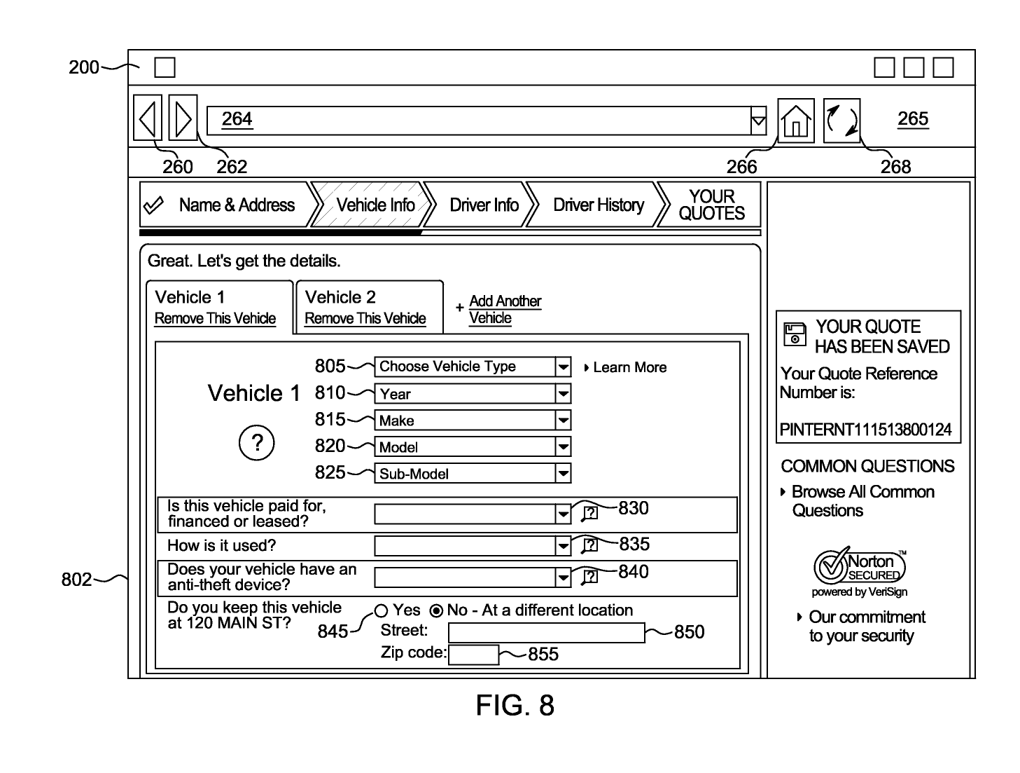

FIG. 8 is an example web page 802 soliciting additional vehicle information regarding a request for a vehicle insurance quote. As shown in FIG. 8, the web page 802 may include radio buttons 805-855, for example, radio buttons Choose Vehicle Type 805, Year 810, Make 815, Model 820, Sub-Model 825, is this vehicle paid for, financed or leased? 830, How Is It used 835, Does your vehicle have an anti-theft device? 840, Yes or No-At a different location 845, Street 850 and Zip code 855. As the user device 130 receives inputs, the web browser module 132 may store one or more data structures (“response data”) that reflect the selections made. Further, as the selections are updated, the web browser module 132 may update the web page 802 to indicate additional or more specific questions that may be associated with the input. The question displayed on web page 802 solicits information regarding the user who is requested to enter vehicle type, year, make, model, and other information. The user is also requested to enter information as to how the vehicle is paid for, how the vehicle is used, whether there is anti-theft equipment, and where the vehicle is stored. The web page 802 also includes tabs to add data for additional vehicles and to remove vehicles. If there are no errors in the transmission, the web browser module 132 is directed to a subsequent web page.

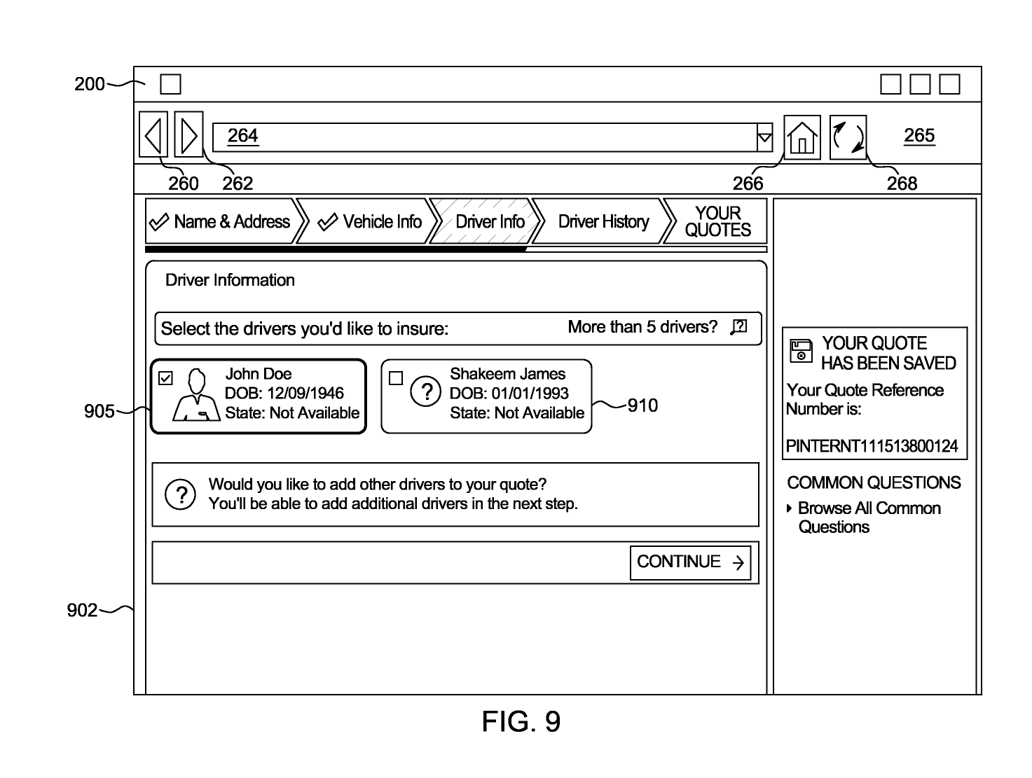

FIG. 9 is an example web page 902 soliciting driver information regarding a request for a vehicle insurance quote. As shown in FIG. 9, the web page 902 may include radio buttons 905 and 910. As the user device 130 receives inputs, the web browser module 132 may store one or more data structures (“response data”) that reflect the selections made. Further, as the selections are updated, the web browser module 132 may update the web page 902 to indicate additional or more specific questions that may be associated with the input. The question displayed on web page 902 solicits information regarding the identity of vehicle(s) for which insurance is being requested. Radio button 905 for example, contains information that is generated based on the user information entered via web page 902. Additionally, the system 100 may be configured to access data associated with the address information and determined suggested drivers, as shown in radio button 910. If there are no errors in the transmission, the web browser module 132 is directed to a subsequent web page.

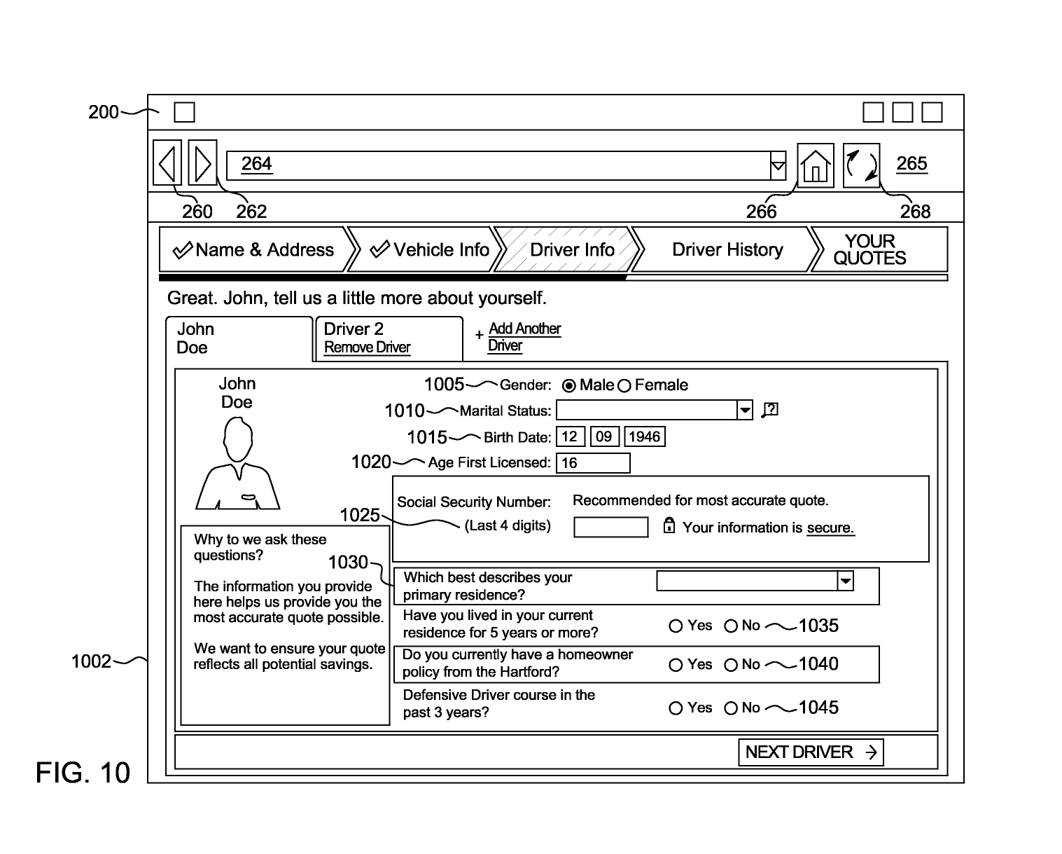

FIG. 10 is an example web page 1002 soliciting additional driver information regarding a request for a vehicle insurance quote. As shown in FIG. 10, the web page 1002 may include input fields 1005-1045, for example, input fields Gender 1005, Marital Status 1010, Birth Date 1015, Age First Licensed 1020, Social Security Number 1025, Which best describes your primary residence 1030, Have you lived in your current residence for 5 years or more 1035, Do you currently have a homeowner policy from the Hartford? 1040, and Defensive Driver course in the past 3 years? 1045. As the user device 130 receives inputs, the web browser module 132 may store one or more data structures (“response data”) that reflect the selections made. Further, as the selections are updated, the web browser module 132 may update the web page 1002 to indicate additional or more specific questions that may be associated with the input. The question displayed on web page 1002 solicits information regarding the identity of vehicle(s) for which insurance is being requested. The system 100 may have access to additional database information to confirm or automatically fill information in the web page 1002. For example, based on the user's social security number, the system 100 may determine background information or confirm the identity. Web page 1002 allows the user to enter all of the additional drivers to be insured, along with their corresponding information. Additional information may also be requested, for example, height, weight, cell phone number, employment information. The system 100 may further be configured to access information, for example from the local department of motor vehicles. This may enable the insurance company to access height and weight information, which may be used for driver destination based underwriting as described in greater detail below. If there are no errors in the transmission, the web browser module 132 is directed to a subsequent web page.

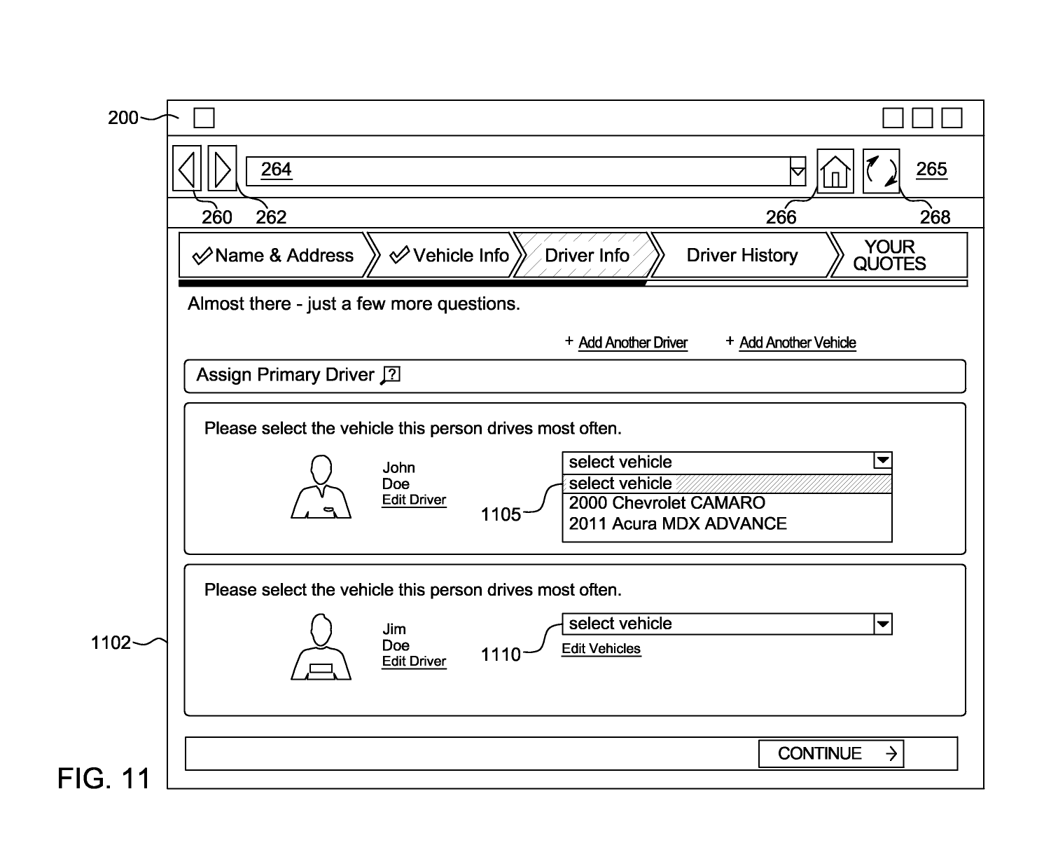

FIG. 11 is another example web page 1102 soliciting additional information regarding a request for a vehicle insurance quote. As shown in FIG. 11, the web page 1102 may include dropdown menus 1105 and 1110. As the user device 130 receives inputs, the web browser module 132 may store one or more data structures (“response data”) that reflect the selections made. Further, as the selections are updated, the web browser module 132 may update the web page 1102 to indicate additional or more specific questions that may be associated with the input. The question displayed on web page 1102 solicits information regarding the primary vehicles being driven by each driver. If there are no errors in the transmission, the web browser module 132 is directed to a subsequent web page.

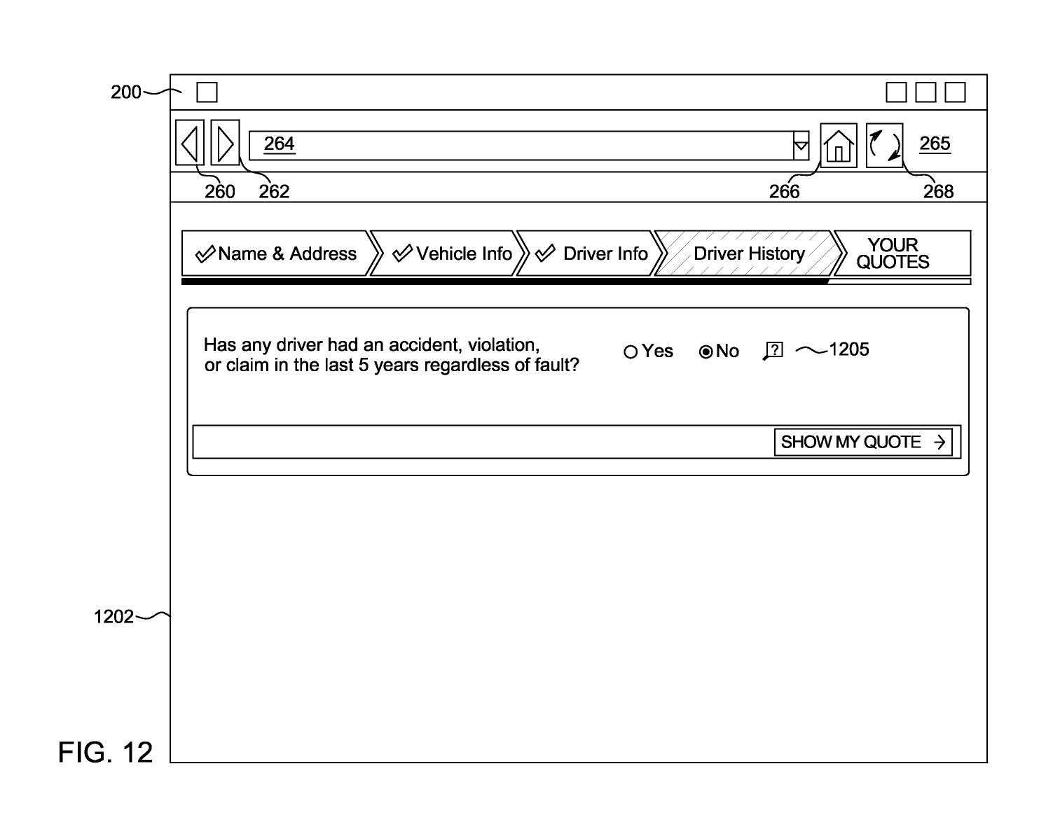

FIG. 12 is an example web page 1202 soliciting driver history information regarding a request for a vehicle insurance quote. As shown in FIG. 12, the web page 1202 may include radio button 1205. As the user device 130 receives inputs, the web browser module 132 may store one or more data structures (“response data”) that reflect the selections made. Further, as the selections are updated, the web browser module 132 may update the web page 1202 to indicate additional or more specific questions that may be associated with the input. The question displayed on web page 1202 solicits information regarding the driver history for each of the drivers. If there are no errors in the transmission, the web browser module 132 is directed to a subsequent web page.

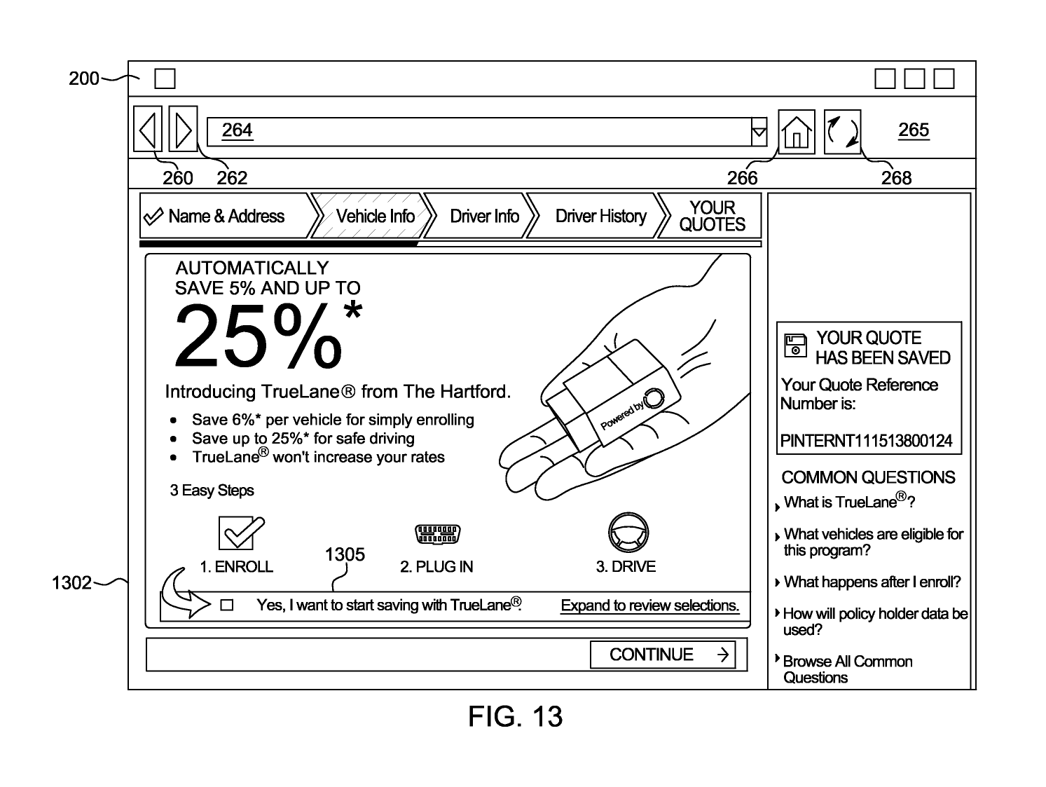

FIG. 13 is an example web page 1302 soliciting a response from the user for registration to TrueLane® telematics program. As shown in FIG. 13, the web page 1302 may include a radio button 1305. As the user device 130 receives inputs, the web browser module 132 may store one or more data structures (“response data”) that reflect the selections made. Further, as the selections are updated, the web browser module 132 may update the web page 1302 to indicate additional or more specific questions that may be associated with the input. Based on the previous answers supplied by the user, the system determines whether the user is eligible for the TrueLane® discount. Alternatively, if the driver or vehicle is in a higher risk category, TrueLane® may be required in order to receive or maintain insurance coverage. The question displayed on web page 1302 confirms enrollment in the TrueLane® telematics program. If there are no errors in the transmission, the web browser module 132 provides a quote.

While the below examples describe a scenario of a new customer registering for insurance and then adjusting the pricing information based on telematics data, the systems and methods described herein may be applied to current and former customers who are looking to renew their coverage. In this scenario, the biographical information may already be stored on the insurance server 180, and the DPU 170 may access this information directly.

The registration phase is used to generate an initial risk assessment, as shown in Table 1, below. During the registration phase, the system 100 received biographical information about each of the drivers who may be associated with the user's account as well as information about the vehicles for which coverage is requested. With millions of accidents each year, a large amount of data is available on factors that may affect the likelihood of an accident as well as the severity of the accident. The database 176 associated with the DPU 170 contains information regarding accident information. The DPU 170, using a multivariate analysis, generates the initial driver assessment based on the provided biographic information verses the factors stored in the database 176. Where allowable by law, one factor that may be used in generating the initial risk assessment is based on the zip code of the insured's home/garaging address. For example, initial risk assessment may be based on a territory risk score assigned using the home/garaging zip code. The territory risk score is based on data such crime data, accident data, weather data etc. that might be considered as direct exposure variables. An example, low resolution, risk assessment is shown below in Table 1.

TABLE 1
Initial Risk Assessment

| | Percentage Time | Location |
|---|---|---|
| Location | Stored in Location | Risk |
| Home | 25 | 1 |
| Office | 40 | 1.5 |
| Low Risk Locations | 7.5 | 0-3.3 |
| Medium Risk Locations | 20 | 3.4-6.6 |
| High Risk Locations | 7.5 | 6.7-10 |

As shown in Table 1, based on the entered biographical information, the initial risk assessment is generated predicting the amount of time the vehicle 140 may be stored in various locations. The DPU 170 may be configured to determine the specific risk associated with the home and office locations entered by the user. Additionally, if a student is listed as a driver, the school may be added as an expected location. The list above is by no means exhaustive. Based on the entered biographical information, the DPU 170 may also be configured to generate an expectation on time spent in low risk, medium risk, and high risk locations (other than the specific expected locations.) This information may be used to generate rate pricing information.

The inside of vehicle 140 may include a plurality of electronics devices that may communicate information to the telematics device. Vehicle 140 may include at least one microprocessor and memory that connects to each individual electronic device. For example, there may be electronic devices associated with the seats, A/C units, global positioning satellite (GPS)/stereo system, DVD unit, and BLUETOOTH equipment. The microprocessor may also be in communication with the headlights, engine, traffic signals, rear view mirror, rearview cameras, cruise control, braking system and inner workings of the vehicle 140. There may also be additional devices such as multiple mobile phones brought by passengers into the vehicle 140. The telematics device is configured to receive information from the electronics in the vehicle. For example, the telematics device is configured to receive data concerning: speed, braking, location, seat settings, lane changes, radio volume, window controls, vehicle servicing, number of cellular devices in a vehicle, proximity to other vehicles, etc. The telematics device may be configured to transmit this information directly to the DCU 110.

The DCU 110 may be configured to format the telematics data (e.g. provide a summary) to the DPU 170. Once the account has been activated, the DPU 170 may be configured to use this information to determine the destination information associated with each vehicle.

The telematics device may be configured to provide telematics data periodically as well as based on a trigger. In one embodiment, if the vehicle 140 is stopped for a predetermined period of time, or the vehicle 140 is turned off, idled, or otherwise stationary, the telematics device may be configured to transmit a signal identifying the location as a stopping point. The telematics device may transmit the recorded information to the DCU 110 which is then transmitted to the DPU 170.

As shown below in Table 2, the DPU 170 may be configured to receive and store location information associated with the vehicle 140 and determines destination information. Based on the reported locations, the system 100 may generate a database with information including stoppage times, the duration of the stoppage, the location of the stoppage, and other factors (e.g. phone in use.) The DPU 170 may be configured to store map information, including nearby businesses and points of interest for each location. Alternatively, the DPU 170 may be configured to communicate with third party applications, such as GOOGLE® Maps, which contain location information about nearby businesses etc. The DPU 170 may determine nearby locations (which may be possible destinations for the driver). The DPU 170 may also be configured to account for other factors, such as stopping for a phone call.

TABLE 2
Measured Destination Information

| | | | | | Loca- | Behav- |
|---|---|---|---|---|---|---|
| Time | Dura- | Phone | Loca- | Nearby | tion | ior |
| Stopped | tion | in Use | tion | Locations | Risk | Risk |
| 1:05am | 1:00 | N | 32606 | Moe's Tavern | 104 | 183 |
| 2:35am | 5:02 | N | 32605 | Home | 100 | 100 |
| 9:07am | 10:13 | N | 32611 | Office | 107 | 154 |
| 8:50pm | 0:14 | Y | 32951 | Highway | 155 | 75 |
| 1:09am | 75:12 | N | 32605 | Home | 100 | 121 |
| 4:43pm | 142:19 | N | 32601 | Airport | 179 | 103 |

The DPU 170 may be configured to analyze the data using a multivariate analysis. Based on the received destination information, the DPU 170 may calculate a direct exposure risk rating and indirect exposure risk rating, where the direct exposure risk rating may comprise physical risks to the vehicle 140 based on the location and indirect exposure risk rating may incorporate behavioral risks.

As an example above, the direct risk exposure may comprise information based on the location risk, which may be affected by vehicle density, lighting, outdoor/indoor parking, storing a vehicle in a neighborhood with a high number of break-ins or thefts, storing a vehicle in areas with high numbers of uninsured drivers. The DPU 170 may be configured to communicate with external servers 190 that may provide detailed crime information for predetermined areas (e.g. 1 meter). Additionally, the DPU 170 may communicate with external servers to determine weather information and real time traffic density and pedestrian density.

The DPU 170 may be configured, using a multivariate analysis to compare the destination information with the initial risk assessment.

The RPU 160 may access the database 176 associated with the DPU 170 to determine adjusted pricing information based on the destination information.

The direct exposure rating may be determined based on loss data associated with a location. The DPU 170 may generate a risk location map, wherein each location is assigned a score. At a macro level, this score may be assigned based on a zip code; however, the risk location map may be generated with more or less granularity. The duration and time of day during which a vehicle is parked at a destination may be accounted for in determining the direct exposure rating. Additional factors may also be accounted for, for example, whether the vehicle is in a garage or the weather associated with each location.

The system may use a multivariate analysis to generate the value of the risk. For example, parking a vehicle 140 in a location known for hail storms may present a high risk of damage; however, if the vehicle 140 is inside a garage, the risk might be mitigated.

Based on the home or garaging location, cited by the user, the risk location map is weighted to set the home location as a value of 100. An example of a risk location map is shown in Table 3, below:

TABLE 3
Risk Location Map

| Zip | Score | % of time parked |
|---|---|---|
| 32605 | 100 | 0.3 |
| 32606 | 104 | 0.1 |
| 32611 | 107 | 0.1 |
| 32951 | 155 | 0.1 |
| 32601 | 179 | 0.5 |

Each location in the risk location map is then compared with the home/garaging location. During the registration phase, the system 100 may only have received information regarding the home or garaging address; accordingly, the initial rate may have been based on that single variable analysis. The DPU 170 may use the telematics data to determine the time spent at each location, as shown in Table 2.

The DPU 170 may then calculate a direct exposure relativity according to Equation 1:

Direct exposure relativity=rates weighted by time spent in the location/rate of home location (Equation. 1)

The direct exposure relativity, calculated by the DPU 170, may also account for the time of day in which the vehicle is stored at a location. For example, parking in a high traffic parking lot may be safe with respect to thefts during the day but more likely to be involved in an accident. But at night, the location may be a high theft area. Accordingly, the direct exposure relativity may further comprise weighting factors for the time of day and duration for which a vehicle is stopped at a destination.

The system 100 may further access additional data to assess the risk of a location for the vehicle 140; for example, the number of accidents or thefts in an area. As the amount of data increases, the system may identify a gradient of vehicle values in an area. Accordingly, a high value vehicle commuting to an area with predominantly low value vehicles may be considered an additional risk.

The indirect exposure rating accounts for behavioral patterns that may be correlated with destinations. Studies have shown correlations between risk appraisal and risky behaviors and the numbers of traffic offenses. Personality traits have been associated with the type of sensation seeking behavior that may result in accidents and therefore the filing of a claim.

Currently, speeding tickets are used to identify a propensity for driver speeding. And propensity for speeding is used to calculate the expectation of an accident or some event for which a claim is filed. However, the number of speeding tickets may not be indicative of the amount of risky behavior exhibited by a driver. For example, one driver may travel at speeds a few mph over the limit on a heavily monitored road, whereas a second driver may speed 30 mph over the speed limit on an unmonitored road. In this scenario, the first driver may receive more tickets, while representing a lower insurance risk. The indirect exposure rating provides the insurance company with additional risk assessment data to further refine insurance rates.

The DPU 170 may be configured to compile information, regarding high risk behaviors, based on the location to which a vehicle is driven. For example, a vehicle that is stopped at a sports stadium, during a big game, the vehicle is more likely to be surrounded with a high number of vehicles that are expected to start moving at approximately the same time. The DPU 170 may contain statistical information that a person at a sporting event is less likely to speed but more susceptible to a low speed fender bender. The DPU 170 may further contain statistical information regarding whether a person attending sporting events is more or less likely to be involved in reckless driving, or more or less likely to be involved in an incident in which a claim is filed.

The indirect exposure rating may further provide granularity and detail to the direct exposure rating. For example, a police impound lot may be determined to be a very safe location, based on the direct exposure rating. There may be a low chance of theft or other damage. However, the indirect exposure rating may account for this as being a risky behavior, since an impounded vehicle may be an indicator that the vehicle is not being properly monitored by the owner.

Accordingly, in addition to the risk location map, the DPU 170 may be configured with a behavior risk map that similarly charts out potential behavior risks associated with each location. An example of a behavior risk map is shown below in Table 4:

TABLE 4
Behavior Risk Map

| | Nearby | Behavior |
|---|---|---|
| Location | Locations | Risk |
| 32606 | Moe's | 183 |
| | Tavern | |
| 32605 | Home | 100 |
| 32611 | Office | 154 |
| 32951 | Highway | 75 |
| 32601 | Airport | 103 |

Using the behavior risk information and the time and duration a vehicle 140 is stopped at a location, the DPU 170 may generate an indirect exposure score. For example, if the DPU 170 detects that a vehicle is parked near a Fenway Park 81 times a year, DPU 170 may indicate this pattern as an increased risk for dangerous behaviors.

The DPU 170 may further be configured to correlate this information with other bibliographical information. For example, biographical information indicates that one of the insured individuals on the account works at said Fenway Park, and then the DPU 170 may determine that the behavior is not a high risk behavior.

To avoid “false positives” that indicate risky behavior, additional measures may be put into place. For example, in the case someone frequently visits a sporting venue, the system may contain measures that avoid the chance of penalizing good Samaritans who may serve as designated drivers for their friends. Accordingly, if the risk factor associated with the location is associated with poor driving afterwards, the system may be configured to monitor driving immediately after leaving the class of location to determine impairment or noticeable changes in driving signature (incorporate other application by reference.)

The system 100 may further be configured to determine whether the vehicle 140 is a self-driving vehicle, in which an on-board computer operates the vehicle. In this case, the effect of the indirect exposure may be reduced when determining the pricing information.

The system 100 uses the biographical information provided in web pages 302-1302 as a baseline for generating the initial pricing information. However, the telematics data, provided by the telematics device may be used to refine this information. The RPU 160 may access the information stored in the DPU 170, and use a software based algorithm to determine whether to adjust the rate or to assess a credit or penalty/surcharge.

In a first example, the system 100 may offer the user a predetermined discount to sign up for the telematics device. The system 100 may be configured to generate a discount factor, for example according to the Equation 2:

Discount relativity=starting discount*β₁ρ₁*β₂ρ₂*β₃ρ₃* . . . βₙρₙ,

where β=weighting factor and ρ=direct and indirect exposure ratings. (Equation 2)

For example, the starting discount may be 10%, and if the product of the direct and indirect exposure ratings with the weighting factors>1, the system 100 may determine the driver is not eligible for a discount.

In one scenario, the system 100 may only receive telematics data for a fixed time period. In this scenario, the RPU 160 may be configured to compensate for the limited duration of the telematics data using a seasonality factor. For example, if the telematics data is received from September-December, and the biographical information indicates one of the insured drivers attends college away from home, RPU 160 may be configured to use the seasonality factor to adjust the pricing information to account for the lack of information transmitted regarding that driver. Conversely, under the same scenario, if the readings were taken during the summer, when the student was home, the telematics data may be skewed the other way. Accordingly, the RPU 160 may use the seasonality factor to account for that.

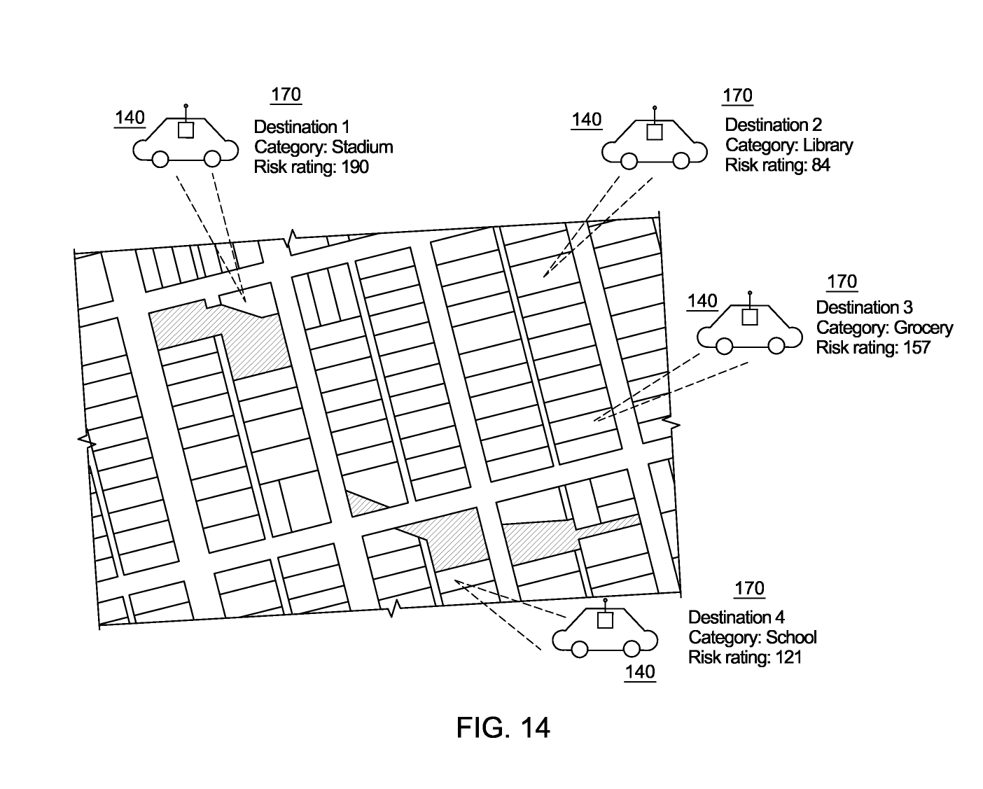

FIG. 14 shows an example of a location risk map used for destination based underwriting. As shown in FIG. 14, the vehicle 140 is monitored as it visits multiple destinations. In FIG. 14, the vehicle 140 is shown stopped at four destinations. When the DPU 170 determines that a vehicle is stopped for a predetermined duration, the DPU 170 identifies a location as a destination. As shown in FIG. 14, the DPU 170 may include a category for each destination. Each destination may further be assigned a location risk rating. As shown in FIG. 14, the stadium has the highest risk rating (190) and the library has the lowest risk rating (84). The DPU 170 determines a risk score based on the risk rating of destination, the duration of stay at each destination, as well as the time of day during which the vehicle is stopped at each destination. The DPU 170 may then compare this versus the home/garaging location, to determine a risk assessment. This risk assessment is used by the RPU 160 to determine updated pricing information.

In another example of destination based underwriting, the DPU 170 may be configured to determine a proxy destination score (PDS) based on a territory rating based on the reported home/garaging address reported at the time of sale of the policy. An example of a PDS is shown below in Table 5 below.

TABLE 5
Proxy Destination Score

| Home/Garaging Zip | Proxy Destination Score (PDS) |
|---|---|
| 32951 | 42 |

The DPU 170 may use the received telematics data to generate a telematics destination score (TDS), for example, based on the techniques explained above. The DPU 170 may further calculate the amount of time spent at the destination, in the aggregate, over the total time of a predetermined period (e.g. a month, six months). An example of a TDS is shown below in Table 6.

TABLE 6
Telematics destination score (TDS)

| | Telematics Destination | % of time at a destination |
|---|---|---|
| Zip | Score (TDS) | within the location |
| 32605 | 11 | 0.3 |
| 32606 | 12 | 0.1 |
| 32611 | 19 | 0.1 |
| 32951 | 42 | 0.4 |
| 32601 | 13 | 0.1 |

The DPU 170 may be configured to standardize the risk scores in both Tables 5 and 6 using multivariate statistical techniques to make them comparable on the same risk scale. The DPU 170 may then determine a destination relativity score, as follows:

Destination relativity=Weighted avg. of rates by time spent in the location unit/home location rate.

Destination Relativity=11*0.3+12*0.1+19*0.1+42*0.4+13*0.1/42= (Equation 3)

The destination relativity may be compared with the expected value to determine whether to adjust the pricing information or continue coverage. For example, based on the determination relativity, the RPU 160 may increase or decrease the rate and/or provide the account with a credit or penalty.

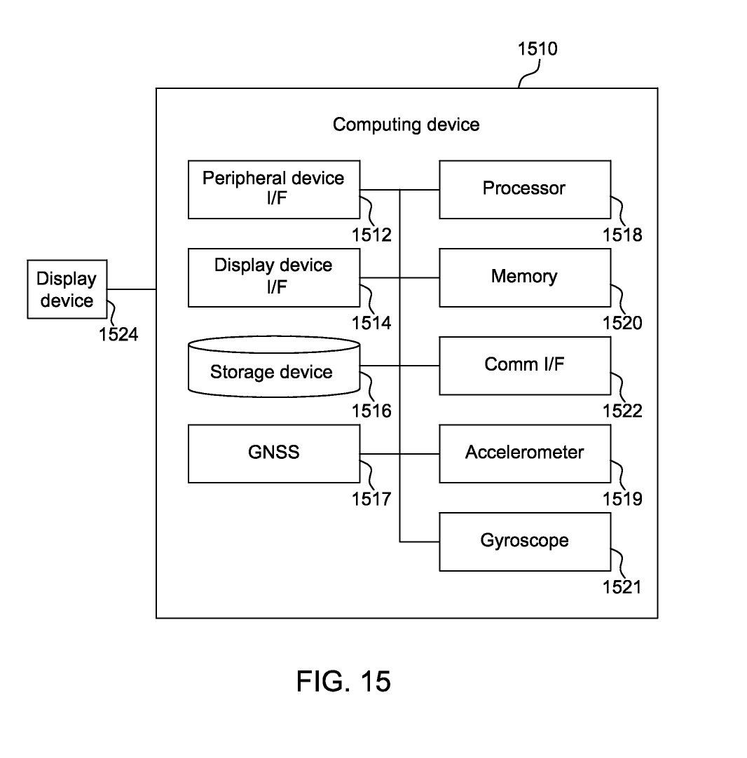

FIG. 15 shows an example computing device 1510 that may be used to implement features described above with reference to FIGS. 1-14. The computing device 1510 includes a global navigation satellite system (GNSS) receiver 1517, an accelerometer 1519, a gyroscope 1521, a processor 1518, memory device 1520, communication interface 1522, peripheral device interface 1512, display device interface 1514, and a storage device 1516. FIG. 15 also shows a display device 1524, which may be coupled to or included within the computing device 1510.

The memory device 1520 may be or include a device such as a Dynamic Random Access Memory (D-RAM), Static RAM (S-RAM), or other RAM or a flash memory. The storage device 1516 may be or include a hard disk, a magneto-optical medium, an optical medium such as a CD-ROM, a digital versatile disk (DVD), or BLU-RAY disc (BD), or other type of device for electronic data storage.

The communication interface 1522 may be, for example, a communications port, a wired transceiver, a wireless transceiver, and/or a network card. The communication interface 1522 may be capable of communicating using technologies such as Ethernet, fiber optics, microwave, xDSL (Digital Subscriber Line), Wireless Local Area Network (WLAN) technology, wireless cellular technology, BLUETOOTH technology and/or any other appropriate technology.

The peripheral device interface 1512 may be an interface configured to communicate with one or more peripheral devices. As an example, the peripheral device may communicate with an onboard diagnostics (OBD) unit that is associated with a vehicle. The peripheral device interface 1512 may operate using a technology such as UNIVERSAL SERIAL BUS (USB), PS/2, BLUETOOTH, infrared, serial port, parallel port, and/or other appropriate technology. The peripheral device interface 1512 may, for example, receive input data from an input device such as a keyboard, a mouse, a trackball, a touch screen, a touch pad, a stylus pad, and/or other device. Alternatively or additionally, the peripheral device interface 1512 may communicate output data to a printer that is attached to the computing device 1510 via the peripheral device interface 1512.

The display device interface 1514 may be an interface configured to communicate data to display device 1524. The display device 1524 may be, for example, an in-dash display, a monitor or television display, a plasma display, a liquid crystal display (LCD), and/or a display based on a technology such as front or rear projection, light emitting diodes (LEDs), organic light-emitting diodes (OLEDs), or Digital Light Processing (DLP). The display device interface 1514 may operate using technology such as Video Graphics Array (VGA), Super VGA (S-VGA), Digital Visual Interface (DVI), High-Definition Multimedia Interface (HDMI), or other appropriate technology. The display device interface 1514 may communicate display data from the processor 1518 to the display device 1524 for display by the display device 1524. As shown in FIG. 15, the display device 1524 may be external to the computing device 1510, and coupled to the computing device 1510 via the display device interface 1514. Alternatively, the display device 1524 may be included in the computing device 1510.

An instance of the computing device 1510 of FIG. 15 may be configured to perform any feature or any combination of features described above as performed by the user device 130. In such an instance, the memory device 1520 and/or the storage device 1516 may store instructions which, when executed by the processor 1518, cause the processor 1518 to perform any feature or any combination of features described above as performed by the web browser module 132. Alternatively or additionally, in such an instance, each or any of the features described above as performed by the web browser module 132 may be performed by the processor 1518 in conjunction with the memory device 1520, communication interface 1522, peripheral device interface 1512, display device interface 1514, and/or storage device 1516.

Although FIG. 15 shows that the computing device 1510 includes a single processor 1518, single memory device 1520, single communication interface 1522, single peripheral device interface 1512, single display device interface 1514, and single storage device 1516, the computing device may include multiples of each or any combination of these components, and may be configured to perform, mutatis mutandis, analogous functionality to that described above.

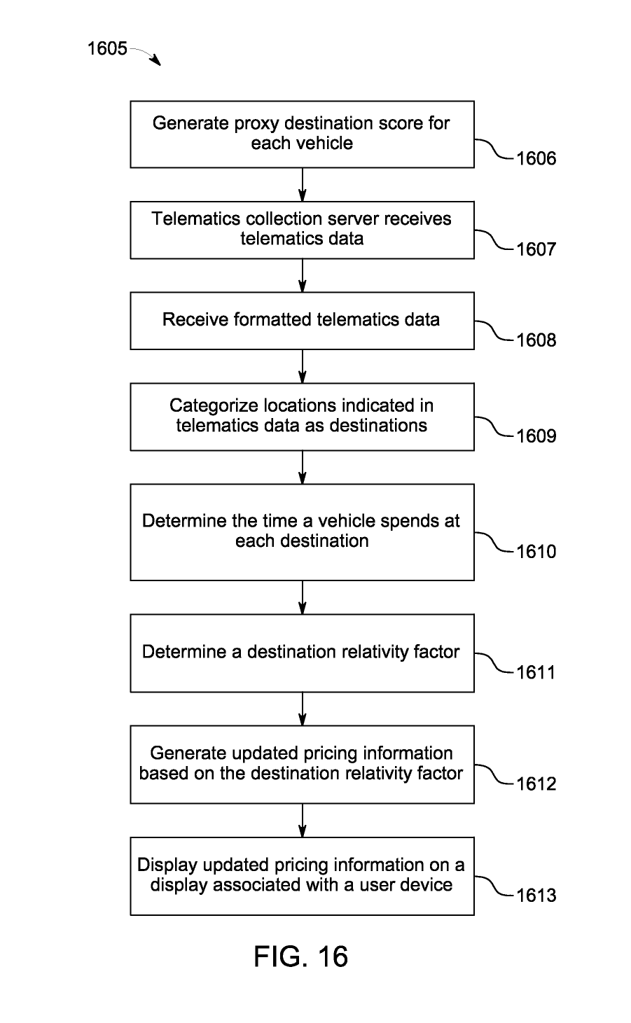

FIG. 16 shows a flow diagram for a method 1605 for destination based underwriting. Based on the received biographical information, the DPU 170 may determine a proxy destination score for each vehicle (step 1606). In one example, the proxy destination score may be based on the home/garaging zip code. As another example, the proxy destination score may be based on previously measured data associated with the vehicle 140 or vehicle owner. A telematics collection server, such as DCU 110 may receive telematics data from one or more telematics devices associated with the vehicle 140 (step 1607). The telematics collection server may format and forward the telematics data to the DPU 170 (step 1608). The DPU 170 may then analyze the received telematics data and categorize locations indicated in the telematics data as destinations (step 1609). Wherein a destination may be determined based on a minimum duration at a location. Based on the evaluation period (e.g. one month, 2 months, year, or time between renewals), the DPU 170 determines the relative percentage of time the vehicle 140 spends at each destination (step 1610). The DPU 170 determines a destination relativity factor based on the percentage of time the vehicle spends at each location, the rating of each location, the home/garaging zip, and the rating of the home/garaging zip (step 1611). The RPU 160 generates updated pricing information based on the destination relativity factor (step 1612). The website 120 may provide the updated pricing information to a user device 130 (step 1613). The updated pricing information may include an adjusted rate, or debits or credits determined by the RPU 160. The web site system 120 may also provide the user device 130 with additional information, such as recommendations on where to store the vehicle to receive a discount.

The system 100 may further include a user transmission device (not pictured) wherein the user transmission device may communicate insurance information, including pricing information, contractual information, information related to the telematics program, and other notifications. A user transmission device may include one or more modes of communication to reach a potential customer, current customer, or past customer or other similar user. For example, the user transmission device may be coupled with a printing device that is automatically mailed to the user. In another embodiment, the user transmission device may be coupled to a device to generate automatic telephone calls, or “robo-calls,” or other similar communication mediums to communicate with the user. The user transmission device may further be configured to send e-mails to a user. The user device may further be configured to communicate via social media.

The system 100 may communicate this information during a renewal period. Additionally, the system may be configured to proactively communicate this information and/or adjust the pricing information based on exposure changes determined by the system 100 that may occur within or outside of the renewal period.

The multivariate predictive model(s) may include one or more of neural networks, Bayesian networks (such as Hidden Markov models), expert systems, decision trees, collections of decision trees, support vector machines, or other systems known in the art for addressing problems with large numbers of variables. In embodiments, the predictive models are trained on prior data and outcomes using a historical database of insurance related data and resulting correlations relating to a same user, different users, or a combination of a same and different users. In embodiments of the present invention, the predictive model may be implemented as part of the DPU 170 or RPU 160 described with respect to FIG. 1.

As used herein, the term “processor” broadly refers to and is not limited to a single- or multi-core processor, a special purpose processor, a conventional processor, a Graphics Processing Unit (GPU), a digital signal processor (DSP), a plurality of microprocessors, one or more microprocessors in association with a DSP core, a controller, a microcontroller, one or more Application Specific Integrated Circuits (ASICs), one or more Field Programmable Gate Array (FPGA) circuits, any other type of integrated circuit (IC), a system-on-a-chip (SOC), and/or a state machine.

As used herein, the term “computer-readable medium” broadly refers to and is not limited to a register, a cache memory, a ROM, a semiconductor memory device (such as a D-RAM, S-RAM, or other RAM), a magnetic medium such as a flash memory, a hard disk, a magneto-optical medium, an optical medium such as a CD-ROM, a DVD, or BLU-RAY Disc, or other type of device for electronic data storage.

Although the methods and features described above with reference to FIGS. 2-16 are described above as performed using the example architecture of system 100 of FIG. 1, the methods and features described above may be performed, mutatis mutandis, using any appropriate architecture and/or computing environment. Although features and elements are described above in particular combinations, each feature or element can be used alone or in any combination with or without the other features and elements. For example, each feature or element as described above with reference to FIGS. 1-16 may be used alone without the other features and elements or in various combinations with or without other features and elements. Sub-elements of the methods and features described above with reference to FIGS. 1-16 may be performed in any arbitrary order (including concurrently), in any combination or sub-combination.

1. A system for determining insurance risk associated with a vehicle, the system comprising:
a receiver, configured to receive information associated with telematics data related to the vehicle;
a processor configured to determine, based at least in part on the telematics data, that the vehicle has reached a destination, a length of time spent at the destination and a time of day during which the vehicle is at a location;
the processor further configured to determine a direct exposure rating for the vehicle based on at least a determined destination, the length of time spent at the destination, and the time of day during which the vehicle is at the location;
the processor further configured to adjust an insurance pricing information related to the vehicle based on the direct exposure rating; and
a transmitter configured to transmit the adjusted pricing information to a user device, user transmission device or web server.

2. The system of claim 1, wherein the direct exposure rating is based at least in part on a location risk factor associated with the destination.

3. The system of claim 2, wherein the location risk factor is based at least in part on a number of claims filed in a predetermined proximity of the location.

4. The system of claim 2, wherein the location risk factor is based on a concentration of uninsured drivers located within a predetermined proximity of the destination.

5. The system of claim 2, wherein the location risk factor is based on a population density within a predetermined proximity of the destination.

6. The system of claim 1, wherein the processor is further configured to adjust the pricing information based on an indirect exposure rating.

7. The system of claim 1, wherein the indirect exposure rating is based at least in part on a behavior risk factor associated with the destination.

8. The system of claim 7, wherein the behavior risk factor is a proximity of the destination to a library.

9. The system of claim 7, wherein the behavior risk factor is a proximity of the destination to a school.

10. The system of claim 7, wherein the behavior risk factor is a proximity of the destination to a sporting venue.

11. A computer based method for determining insurance pricing information associated with a vehicle, the method comprising:
receiving, by a receiver, information associated with telematics data related to the vehicle;
determining, by a processor, based at least in part on the telematics data, that the vehicle has reached a destination, a length of time spent at the destination and times of day during which the vehicle is at a location;
determining, by the processor, a direct exposure rating based on at least the determined destination, the length of time spent at the destination, and the times of day during which the vehicle is at the location;
adjusting, by the processor, insurance pricing information associated with the vehicle based on the direct exposure rating; and
transmitting, by a transmitter, the adjusted pricing information to a user device, user transmission device or web server.

12. The method of claim 11, wherein the adjusted pricing information includes an updated insurance rate.

13. The method of claim 11 wherein the adjusted pricing information is a discount or surcharge.

14. The method of claim 11, further comprising displaying, by a display associated with the user device, the adjusted pricing information.

15. The method of claim 11, further comprising, adjusting the pricing information at a renewal period of an insurance policy.

16. The method of claim 11, further comprising based at least in part on an indirect exposure rating.

17. The method of claim 11, further comprising, determining, by the processor whether a vehicle is in a garage or outdoors.

18. A system for determining insurance pricing information associated with a vehicle, the system comprising:
a receiver, configured to receive information associated with telematics data related to the vehicle;
a processor configured to determine, based at least in part on the telematics data, a direct exposure rating for the vehicle based on at least the determined destination and the length of time spent at the destination;
the processor further configured to determine, based at least in part on the telematics data, an indirect exposure rating for the vehicle based on at least the determined destination and the length of time spent at the destination; and
the processor further configured to adjust an insurance pricing information related to the vehicle based on the direct and indirect exposure rating.

19. The system of claim 1, wherein the direct exposure rating is based at least in part on a location risk factor associated with the destination.

20. The system of claim 1, wherein the indirect exposure rating is based at least in part on a behavior risk factor associated with the destination.
